(19) United States
(12) Patent Application Publication
(10) Pub. No.: US 2006/0239113 A1
(43) Pub. Date: Oct. 26, 2006

(54) Homogeniser

(76) Inventors: Mark Beaven Harris, Huntly (NZ); Thomas Stuart Ritchie, Hamilton (NZ)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/511,789

(22) PCT Filed: Apr. 15, 2003
(86) PCT No.: PCT/NZ03/00066

§ 371 Date: Jun. 16, 2005

(30) Foreign Application Priority Data
Apr. 16, 2002 (NZ) 518432

(51) Int. Cl. B01F 15/00; B08B 9/00; B08B 3/00

(52) U.S. Cl. 366/129; 134/34; 134/22.1

(57) ABSTRACT

A homogeniser (1) including: a housing; a drive mechanism (3) located within said housing (2); and a cutting element (4) attached to said drive mechanism (3), characterised in that at least part of said drive mechanism (3) is reversibly movable within said housing (2) between a position in which said cutting element (4) is located within said housing (2) and a position in which the cutting element (4) at least partially projects outside said housing (2) and thereby cleaning of same.

### TECHNICAL FIELD

The present invention relates generally to a homogeniser and in particular a mechanism for cleaning same and method of performing the said cleaning.

### BACKGROUND ART

Homogenisers are used in various applications to puree, pulp pulverize, blend and otherwise homogenise a substance ranging from liquids such as milk wherein the fat content is emulsified to render the milk of a uniform consistency, to solids and semi-solid matter such as meat samples. Homogenisers generally employ a high speed rotating cutting implement which reduces the sample to particles and disperses them throughout the fluid/slurry formed from the original sample. Whilst some samples may be substantially liquid, others are samples are significantly gelatinous, fibrous and/or otherwise difficult to reduce completely to liquid form.

In laboratory testing conducted on these samples, small volumes of meat substance are required to be homogenised to extract meat fluids on which the tests are performed. At present, homogenisers employed for this task quickly become clogged and require cleaning due to the fibrous nature of the sample. The avoidance of cross-contamination also requires the cleaning of the homogenizer between each sample. As the cost effectiveness of laboratory tests and the efficiency of same depend on the speed in which the large numbers of test can be formed, any reduction in the cleaning time of the homogeniser is clearly desirable.

To clean known homogenisers currently employed in comparable tasks, it is necessary to at least partially dismantle the homogeniser housing and motor unit in order to extract the cutting element. Clearly this is disadvantageous in both practical and economic terms. To avoid cross contamination the most commercial companies require test samples to be sterilised to a level termed a gross clean (99.5% clean) rather than autoclaving between every sample. Currently, the cycle time for cleaning the homogeniser can be at least 1-2 minutes or more.

In order to be cleaned, the homogeniser unit needs to be removed from the motor, the cutting element removed from the housing and the cleaning operation performed. Not only is this process unduly protracted, the steps involved do not readily lend themselves to automation.

There exists the need for improved means of cleaning the homogeniser without dismantling the unit with a reduced cleaning cycle time.

None of the known prior art addresses these needs. More specifically:

U.S. Pat. No. 6,193,404 CALANGE discloses a portable hand-held electric blender in which the novel features relate to the ability to detach the rotating tool and surrounding housing for cleaning purposes. Whilst this does facilitate cleaning of the rotor tool, the process is time-consuming and not intended for automation. Furthermore, there is no disclosure of a means of extending the tool/rotor outside the surrounding housing while still being attached to the electric drive.

U.S. Pat. No. 5,863,118 ACRELS ET AL discloses a hand-held domestic blender primarily for food preparation and the like and provides a means of varying the actual length of the blender housing/shaft to optimise use in differing configurations of container. To achieve this aim, a slidable coupling arrangement permits the rotating tool/shaft head to be extended away from the motor to increase the effective length of the blender. However, there is no disclosure of projecting the tool/rotor head outside of the housing for rapid cleaning purposes.

U.S. Pat. No. 6,186,056 BRUNO ETAL discloses a further food processing tool operating on broadly similar principles to conventional hand-held blenders. This invention is specifically directed towards the difficulties in cleaning such devices and sealing the rotating parts/motor from product ingress. However, this is achieved by the relatively time-consuming process of detaching the rotating blade from the housing/shaft drive by means of a specialised tool.

U.S. Pat. No. 6,293,691 REBORDOSA ETAL describes a handheld food blending device with a protective shield surrounding the rotor blade. The shield is movable to enable the rotor head to be positioned at different points within the shield so as to interact more efficiently with food of different sizes. However, there no disclosure of a means to project the rotor head outside the shied to facilitate rapid cleaning.

U.S. Pat. No. 6,398,403 REBORDOSA ET AL also discloses a hand-held domestic blender, incorporating a rotor blade guard configured with a wall configuration composed of repeating undulations and recesses. Although the guard wall shape is designed to enhance the recirculation and consequent comminution of the food, there is no teaching of any improvement in the manner of cleaning said device and in particular, no teaching of projecting the rotor blade outside the guard wall for cleaning.

U.S. Pat. No. 6,523,990 LEE relates to improvements in the shaft mounting of the motor in a hand-held domestic blender. Whilst the rotor-shaft/motor coupling is described in detail, there is no disclosure of any feature capable of improving the speed of manner of cleaning the blender. In particular, there is no disclosure of projecting the rotor blade outside the guard wall for cleaning.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term. ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a homogeniser including:
a housing;
a drive mechanism located within said housing; and
a cutting element attached to said drive mechanism,
   characterised in that at least part of said drive mechanism is reversibly movable within said housing between a position in which said cutting element is located within said housing and a position in which the cutting element as at least partially projects outside said housing and thereby facilitating cleaning of same.

According to another aspect of the present invention there is provided a homogeniser substantially as described above wherein said housing includes an outer projection with a bearing surface capable of engaging with one or more objects external from the homogeniser to thereby restrain movement of said housing whilst allowing said drive mechanism and cutting element assembly to be movable with respect to said housing.

According to one embodiment, the housing is a substantially tubular cylinder open at a first end. Preferably during homogenising operations, the cutting element is located at said first end within the volume of the cylinder boundaries.

Preferably, the housing at said first end includes a plurality of slots and/or apertures. In one embodiment, the slots/apertures are a series of castellations radially disposed about said first end of the cylinder. The cutting element may preferably be formed from one or more blades.

According to one aspect of the present invention, the said outer projection is an annular flange, preferable located about a substantially intermediate point between the ends of said cylindrical housing. Preferably, at least one said external object is a circular or part-circular opening. In one embodiment, the circular opening is provided by an open-end of a substantially cylindrical vessel. It will be appreciated however, that many alternative configuration of external object are possible, and as such fall within the scope of the invention.

As used herein, the term homogeniser includes any device capable of blending, stirring, mixing, pureeing, and/or chopping a sample into smaller constituent particles.

The term ‘drive mechanism’ used herein refers to any appropriate means of providing powered movement to the cutting element and/or a linkage thereto, including (but not limited to) electrical, pneumatic, hydraulic, inductive powered drives and/or mechanical, electromechanical, electrical, or other power linkage or transmission means and the like.

In one embodiment, said reversibly movable drive mechanism or part thereof within said housing is formed as one stator of two-stator electric motor, the other stator being fixed to the electric motor and/or said housing.

Whilst typical homogeniser configurations used for preparing scientific samples for analysis are essentially devices with elongated cylindrical housings, the invention should not be seen as being limited to same.

The present invention may operate in a conventional manner to that of known homogenisers when homogenising a substance. However, when a different sample is to be homogenised without the risk of cross-contamination, or when the homogeniser cutting element becomes unacceptably clogged, some form of cleaning must be performed.

The cleaning action may be performed by a variety of means. In one embodiment, cleaning is performed by spraying cleaning fluid over the cutting element when positioned at least partially projecting outside said housing. Alternative cleaning means include, but are not limited to, immersing the cutting element in a cleaning agent, the use of cleaning swabs, pads, brushes and so forth.

One or a plurality of cleaning nozzles may be used to apply jets of cleaning fluid, preferably under pressure to dislodge any residual sample material adhered to the cutting element. Preferably, the cleaning nozzles are located in said external object configured as a substantially cylindrical vessel. It will be appreciated however, that the external object engaging the said bearing surface need not necessarily form part of the cleaning mechanism itself.

Unless the cutting element can be moved outside the homogeniser housing, the cleaning of same will be impeded. The speed and ease by which this configuration may be achieved impacts on the efficiency of the cleaning process. Current cleaning processes for comparable homogenisers used in the repeated preparation of samples to a laboratory standard involve the dismantling of the drive mechanism and/or detachment of the cutting element. This is clearly time-consuming, potentially requiring a degree of physical dexterity is subject to inevitable cycle time fluctuations and requires the input of an appropriately trained operative. Thus, automating the cleaning process, or at least providing increased consistency, repeatability and reduced cycle times is desirable.

During sequential preparation of numerous samples for laboratory testing requiring the homogenising of each sample, the cycle time required to perform cleaning is a key factor. The ability to automate cleaning of the homogeniser reduces the cleaning cycle time, increases consistency, reducing the need for manual intervention and potentially increases cleanliness. The present invention lends itself to use in an automated cleaning process.

Thus, according to a further embodiment, the present invention provides a method of cleaning a homogeniser cutting element, said homogeniser including,
a housing with an outer projection configured with a bearing surface;
a drive mechanism located within said housing with said cutting element attached to the drive mechanism,
   at least part of said drive mechanism being reversibly movable within said housing between a position in which said attached cutting element is located within said housing and a position in which the cutting element is as at least partially projects outside said housing,
   said method characterized by the steps of
restraining movement of said housing by engaging said bearing surface with a fixed external object;
moving said drive mechanism and cutting element assembly with respect to the housing until the cutting element at least partially projects from the housing; and
cleaning the cutting element.

Optionally, said drive mechanism is operated during cleaning to pulse, agitate or otherwise move the cutting element.

According to a further embodiment, said method step of restraining movement of said housing is accomplished by inserting the homogeniser into an opening in a cleaning vessel until said bearing surface contacts said opening.

Preferably, said cleaning of the cutting element is performed by nozzles located within the cleaning vessel spraying cleaning fluid across the cutting element.

Furthermore, said cleaning nozzles and/or the homogeniser may move or oscillate with respect to each other during cleaning.

Thus, the present invention provides a homogeniser which is effective and efficient in operational use, which reduces maintenance costs, and which by virtue of its construction permits the cutting element to be readily cleaned without dismantling.

### BRIEF DESCRIPTION OF DRAWINGS

Further aspects of the present invention will become apparent from the following description which is given by way of example only and with reference to the accompanying drawings in which:

FIG. 1 shows a perspective view of a preferred embodiment of the present invention in the form of a homogeniser;

FIG. 2 shows an exploded perspective view of the homogeniser shown in FIG. 1;

FIG. 3 shows a side elevation of the homogeniser shown in FIG. 1 in an operating configuration used during homogenization;

FIG. 4 shows a section along the line AA of the homogeniser shown in FIG. 3;

FIG. 5 shows a side elevation of the homogeniser shown in FIG. 1 with the cutting element projecting from the homogeniser in a configuration used during cleaning;

FIG. 6 shows a section along the line BB of the homogeniser shown in FIG. 5; and

FIG. 7 shows a section through the homogeniser shown in FIGS. 1-6 inserted into a vial for containing a sample substance to be homogenised.

### BEST MODES FOR CARRYING OUT THE INVENTION

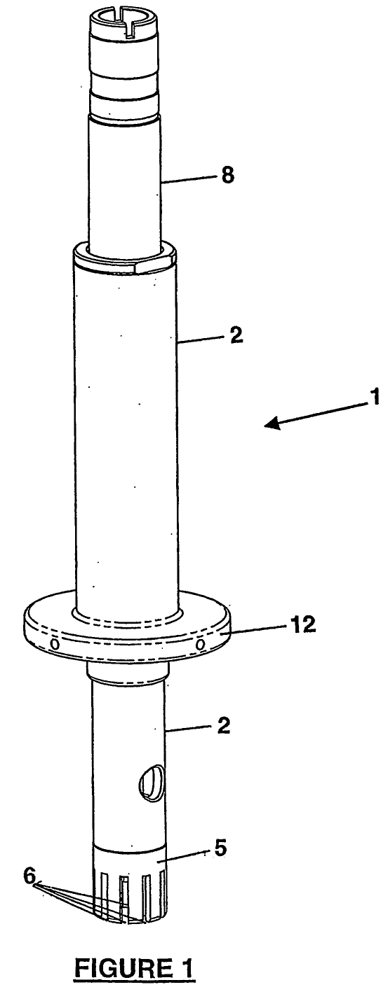

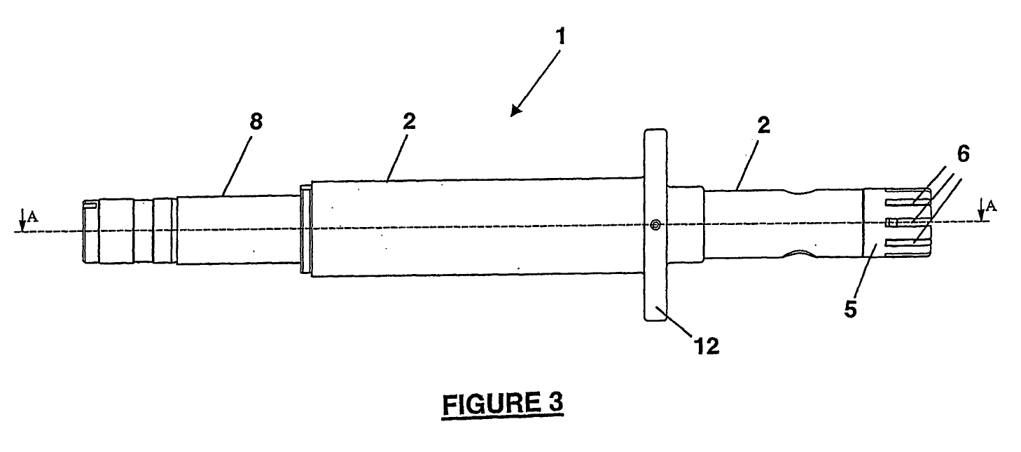

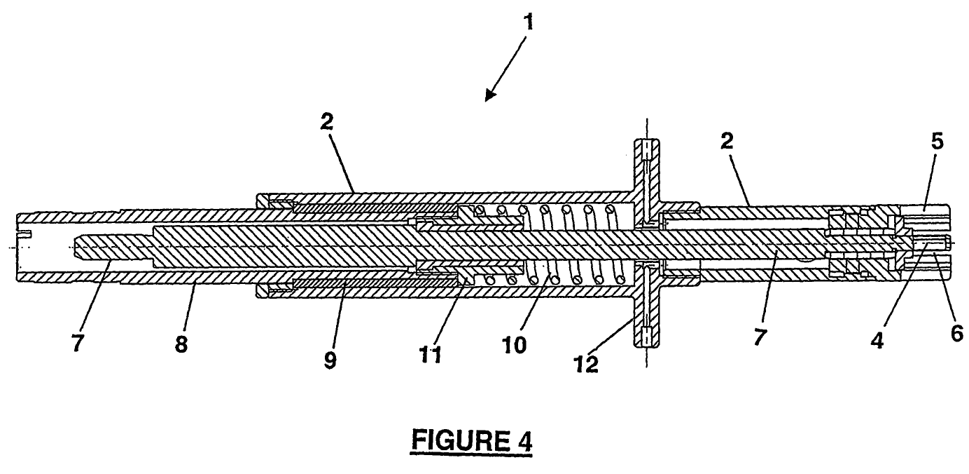

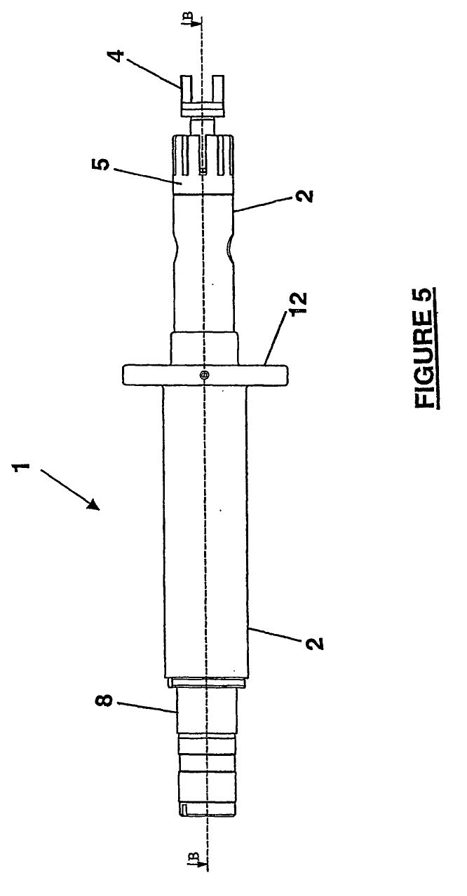

In FIGS. 1-6, a preferred embodiment of the present invention in the form of a homogeniser (1) is shown for the purposes of explanation and illustration. The homogeniser (1) is composed of a housing (2), a drive mechanism (3) and a cutting element in the form of a rotor tip (4).

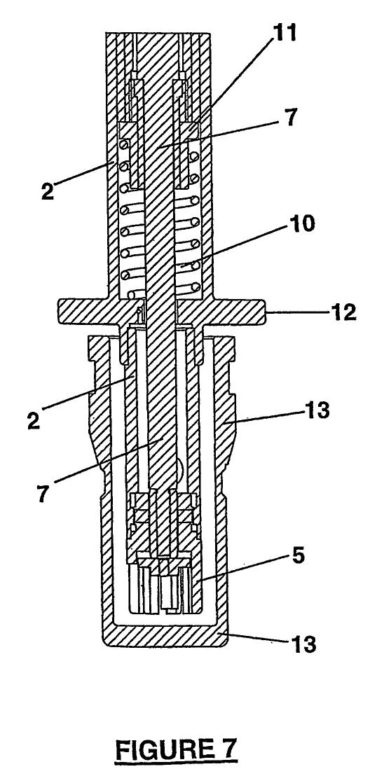

The housing (2) is formed as a substantially elongated cylindrical sleeve having a first and second open end. At the first end, a rotor guard (5) is located, comprised of a tubular extension of the housing (2) adjacent to the rotor tip (4) with a plurality of slots or castellations (6) equidistantly disposed about the circumference of the distal end. In FIGS. 1, 3 and 7, the rotor tip (4) is shown in its operating position, i.e. as used during homogenisation of a sample material. In use, the rotor tip does not protrude beyond the extremities of the rotor guard (5) as this may lead to injury to the operator or damage to the container holding the sample material (not shown).

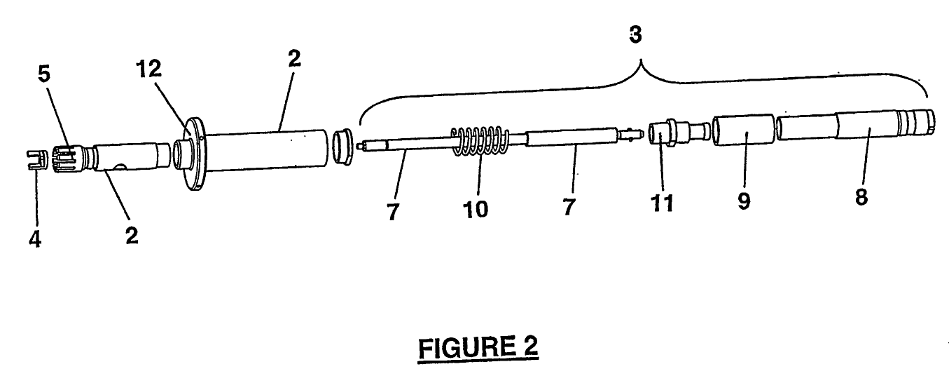

In the preferred embodiment shown in the drawings the homogeniser (1) is attached to an electric motor (not shown) to provide power during homogenisation. The electric motor provides rotational movement to the rotor tip (4) via the drive mechanism (3) located within, and extending from, the housing (2). This may be more clearly seen in FIG. 2 showing an exploded view of the homogeniser (1) components. The drive mechanism (3) is comprised of numerous sub-components including a rotatable shaft (7) orientated along the longitudinal axis of the homogeniser (1). One end of the rotatable shaft (7) located towards the first end of the housing (2) releasably engages with the rotor tip (4) whilst the other end (towards the second end of the housing (2)) engages with the electric motor drive (not shown).

The end of the rotor shaft (7) distal from the rotor tip (4) is positioned inside a substantially cylindrical stator (8) which is itself rotatably located in the housing (2) by a tubular bush (9). This configuration permits the motor (not shown) to provide rotational motion via the stator (8), and the rotor shaft (7), to the rotor tip (4).

During homogenising operation, the sample material to be homogenised is sucked in through the base of the unit, reduced to particles by the action of the rotor tip (4) and expelled laterally outwards through the castellations/gratings (6) of the rotor guard (5).

This action is directly comparable to existing homogenisers of this type and is particularly suited for use in laboratory testing situations utilizing small sample volumes with the requirement for no cross-contamination between samples. The homogeniser embodiment shown in the drawings is particularly suitable for use with homogenising fibrous, stringy and or gelatinous material such as meat samples which need to be homogenised in order to extract meat fluids on which tests may be preformed. It will however be understood that the invention need not be necessarily be limited to same and that alternative applications and/or configurations are possible and fall within the scope of the invention.

As may be seen from FIGS. 2, 4, 6 and 7, the drive mechanism (3) is spring-mounted within the housing (2) by means of a coiled spring (10) which acts (at one end) against a spring locator flange (11) and (at the other end) against a stop within the housing (2). The action of the spring (10) acts to maintain the drive mechanism (3) and attached rotor tip (4) in the retracted position used during homogenisation.

The application of a force along the longitudinal axis of the homogeniser towards the rotor tip (4) would cause movement of the entire hornogeniser (1) unless otherwise restrained. If the housing (2) is fixed by some means, the drive mechanism (3) together with the attached rotor tip (4) is able to slid within the housing (2) against the resistive force of the closed spring (10) until the spring (10) becomes coil bound or encounters an internal stop/obstruction. The movement of the drive mechanism (3) within the housing (2) causes rotor tip (4) attached to rotor shaft (7) to extend beyond the rotor guard (5).

This facilitates cleaning of the rotor tip (4) in particular and the rotor guard (5) and lower housing (2) in general. Dependant on the type of sample material being homogenised, the recesses between the rotor tip (4) and the cavity guard (5) can be prone to collection of detritus, sample fibres and the like. Cleaning this region is clearly hindered unless the rotor tip (4) is moved out of the confined of the rotor guard (5). This may be achieved by manually dismantling the homogeniser to remove the rotor tip (4) from the rotor shaft (7) and/or detaching the rotor shaft (7) from the motor (not shown) and the housing (2). However, this is both time consuming and inefficient.

Automating the means of extending the rotor tip (4) outside the rotor guard (5) for cleaning may be performed by engaging a portion of the housing (2) with a fixed external object (not shown) whilst applying a force to the drive mechanism (3) along the longitudinal axis of the homogeniser (1). An annular flange (12) is located at an intermediate point between the first and second ends of the housing (2), extending outwards substantially orthogonally from the surface of the housing (2). The annular surface of the flange (12) facing towards the rotor tip (4) acts as a bearing surface to engage with an external object to restrict the movement of the housing (2) in a direction towards the rotor tip (4).

One convenient configuration of an external object to engage with the circular flange (12) is the edge of a correspondingly sized circular aperture. In a preferred embodiment, the homogeniser (1) attached to a motor (not shown) is movable by automated transport means (e.g. electrical, hydraulic, or pneumatic drives) from homogenising a sample material in a vial (13) for example, to a cleaning station (not shown) for automated cleaning.

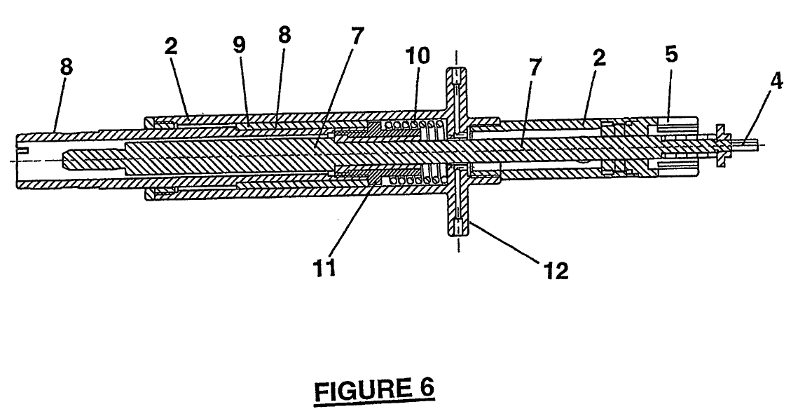

In one embodiment, the cleaning station is comprised of a substantially cylindrical vessel apertured at one end, into which the homogeniser (1) is inserted (rotor tip (4) first) until the flange (12) contacts the aperture surrounds. Further application of force in the direction of insertion leads the movement of housing (2) to be constrained by the contact with the cleaning vessel. However, the drive mechanism (3) and attached rotor tip (4) are free to move until the spring (10) becomes coil bound (as shown in FIG. 6) leaving the rotor tip (4) protruding outside the rotor guard (5).

Cleaning of the homogeniser (1) may be undertaken by any convenient means, though it has been found effective to utilize jets of cleaning fluid sprayed across the relevant portions of the rotor tip (4), rotor guard (5) and housing (2). During the cleaning action, the motor may be pulsed to agitate the rotor tip (4) to further facilitate the effectiveness of the cleaning jets.

The cleaning vessel may be configured such that when the homogeniser is inserted through the open aperture of the cleaning vessel until the rotor tip (4) is exposed, the flange (12) substantially seals the void between the cleaning vessel and the housing (2), thereby preventing splashing, spray and the like. Further enhancements to the cleaning process include moving one or both of the cleaning jets and or the homogeniser in a reciprocating manner.

The rapidity and ease of use by which the homogeniser (1) may be cleaned may be utilized in a number of applications. One particular application (not shown) is the incorporation of the homogeniser (1) in an automated sample testing system comprised of a rotating carousel on which a plurality of vials (15) are moved between a number of stations. In one configuration, the carousel may include:
a vial loading/unloading station;
a homogeniser station;
a filter station; and
a testing station.

The vial loading/unloading station would supply fresh samples of meat portions for example in individual vials and remove the used vials on which testing had been conducted. Any convenient means of effecting the vial transfer may be employed as a servo-operated robotic arms and the like.

The homogeniser station may employ a homogeniser as per the present invention whose movement is also controlled by a robotic arm. The homogeniser would be inserted into a new vial to homogenise the sample and then extracted, and moved to an adjacent cleaning station. The act of inserting the homogeniser into the cleaning station causes the cutting element to be projected outside the homogeniser housing to facilitate cleaning as described above. The cleaned homogeniser is then inserted into a new sample vial and the sequence is repeated.

The homogenised vial is then rotated in the carousel to the filter station where a filter is inserted in to the vial and sample fluid extracted. Due to the fibrous nature of meat samples, the filter will become clogged with unwanted detritus. Cross contamination between samples is also undesirable. Thus, the filter is also cleaned between filtering each sample by any suitable means.

The filtered sample fluid is then passed to the appropriate testing apparatus and the entire process repeated. Such a system permits rapid cycle times, enabling large sample batches to be efficiently processed with of greater consistency to previous systems. Furthermore, the concatenation of the entire time taken to process all the samples ensures minimal effects from differing environmental or climatic variations during the testing procedure.

It will be appreciated by one skilled in the art that there are many variations in homogeniser configuration, application, and implementation which fall within the scope of the present invention.

The drive mechanism described with respect to the embodiment shown in the drawings is a mechanical power transfer means for transmitting the rotational movement of an electric motor to the cutting element. However, the homogeniser housing itself may incorporate an electric motor, the rotor shaft may be extended by a screw motion instead of a purely linear action, to give just two possible variants. All such variants would nevertheless give the ability to extend the cutting element from its surrounding housing for cleaning without necessarily requiring manual intervention, nor the dismantling of the homogeniser to effect cleaning.

Aspects of the present invention have been described by way of example only and it should be appreciated that modifications and additions may be made thereto without departing from the scope thereof.

1. According to one aspect of the present invention there is provided a homogeniser including
a housing;
a drive mechanism located within said housing; and
a cutting element attached to said drive mechanism,
characterised in that at least part of said drive mechanism is reversibly movable within said housing between a position in which said cutting element is located within said housing and a position in which the cutting element at least partially projects outside said housing and thereby facilitating cleaning of same.

2. A homogeniser as claimed in claim 1, wherein said housing includes an outer projection with a bearing surface capable of engaging with one or more objects external from the homogeniser to thereby restrain movement of said housing whilst allowing said drive mechanism and cutting element assembly to be movable with respect to said housing.

3. A homogeniser as claimed in any one of the claim 1 wherein the housing is a substantially tubular cylinder open at a first end.

4. A homogeniser as claimed in claim 3, wherein during homogenising operations, the cutting element is located at said first end within the volume of the cylinder boundaries.

5. A homogeniser as claimed in claim 3, wherein the housing at said first end includes a plurality of slots and/or apertures.

6. A homogeniser as claimed in claim 5, wherein the slots/apertures are a series of castellations radially disposed about said first end of the cylinder.

7. A homogeniser as claimed in claim 1, wherein the cutting element is formed from one or more blades.

8. A homogeniser as claimed in claim 2, wherein the said outer projection is an annular flange, preferably located about a substantially intermediate point between the ends of said cylindrical housing.

9. A homogeniser as claimed in claim 2, wherein at least one said external object is a circular or part-circular opening.

10. A homogeniser as claimed in claim 9, wherein the circular opening is provided by an open-end of a substantially cylindrical vessel.

11. A homogeniser as claimed in claim 1, wherein said reversibly movable drive mechanism or part thereof located within said housing is formed as one stator of two-part stator electric motor, the other stator being fixed to the electric motor and/or said housing.

12. A method of cleaning a homogeniser cutting element, said homogeniser including,
a housing with an outer projection configured with a bearing surface;
a drive mechanism located within said housing with said cutting element attached to the drive mechanism,
at least part of said drive mechanism being reversibly movable within said housing between a position in which said attached cutting element is located within said housing and a position in which the cutting element at least partially projects outside said housing,
said method characterized by the steps of
restraining movement of said housing by engaging said bearing surface with a fixed external object;
moving said drive mechanism and cutting element assembly with respect to the housing until the cutting element at least partially projects from the housing; and
cleaning the cutting element.

13. A cleaning method as claimed in claim 12, wherein said drive mechanism is operated during cleaning to pulse, agitate or otherwise move the cutting element.

14. A cleaning method as claimed in claim 12, wherein said method step of restraining movement of said housing is accomplished by inserting the homogeniser into an opening in a cleaning vessel until said bearing surface contacts said opening.

15. A cleaning method as claimed in claim 14, wherein said cleaning of the cutting element is performed by nozzles located within the cleaning vessel spraying cleaning fluid across the cutting element.

16. A cleaning method as claimed in claim 14, wherein said cleaning nozzles and/or the homogeniser may move or oscillate with respect to each other during cleaning.

17-18. (canceled)
